(19) United States
(12) Patent Application Publication
(10) Pub. No.: US 2005/0061171 A1
(43) Pub. Date: Mar. 24, 2005

(54) System of punching or printing

(76) Inventor: Bartesaghi Angelo, Lecco (IT)

Correspondence Address: SHERIDAN ROSS PC, 1560 BROADWAY, SUITE 1200, DENVER, CO, 80202, US

(21) Appl. No.: 10/933,991

(22) Filed: Sep. 2, 2004

(30) Foreign Application Priority Data
Sep. 4, 2003 (IT) MI2003A 001703
Jun. 4, 2004 (EP) 04013213.6

(51) Int. Cl. B41F 13/56

(52) U.S. Cl. 101/226

(57) ABSTRACT

A description is given of a punching machine (100) for the punching of tape material (5) comprising a first and a second punching turret (A, B) placed in line and each one provided with a pair of opposite rotating cylinders (2A, 2B) holding respective punching blade sheets (3A, 3B) which define the shape and the lay-out of the punched parts (8, 9) to be obtained, in such a way that the tape is punched alternately by the first and by the second punching turret (A, B).

A description is also given of a printing machine (200, 300, 400, 500) comprising a first and a second printing turret (A, B) placed in line and each one provided with a print contrast cylinder (212A, 212B) and with a plate support cylinder (203A, 203B) which defines the shape and the lay-out of the print to be obtained, in such a way that the tape is printed alternately by the first and by the second printing turret (A, B).

The present invention relates to a punching or printing system for a punching machine or a printing machine and to a relative method of punching or of printing, in particular for the punching of cases, boxes and other products in board, as also for the punching of self-adhesive labels and for printing a tape.

According to the prior art a punching machine generally comprises a pair of opposite cylinders whereon the cutting templates are formed so as to allow punching of the sheet material which is fed between the cylinders. As a result the external diameter of the cylinder defines the length (or development) of the punched part, that is to say each punched part will have a length equal to the circumference of the cylinder.

As a result of each production change, that is to say when the length and/or the shape of the punched part is to be changed, the cylinders have to be replaced, resulting in long down times with the machine at a standstill.

This problem is at least partially solved by more advanced punching machines comprising a pair of cylinders, commonly referred to as magnetic cylinders since respective blade sheets are mounted thereon by magnetic retaining, and which, having an arc profile, only partially occupy the length of the circumference of the magnetic cylinder.

In this case the length of the punched part is determined only by the length of the circumference arc of the blade sheet and not by the length of the entire circumference of the magnetic cylinder. Consequently, in order to change the length and/or the shape of the punched part it is sufficient to replace only the blade sheet with another blade sheet of different shape and length.

However it has to be considered that, if the tape material is fed between the magnetic cylinders at a constant speed, a punched part would be obtained in output therefrom with length equal to the length of the blade sheet and a portion of non-punched tape material with length equal to the difference between the length of the circumference of the magnetic cylinder and the length of the blade sheet. Consequently this system of punching would entail an excessive waste of material, above all in the case of blade sheets with a small length.

This disadvantage is at least partially solved in the European patent application EP 1 249 418 wherein it is proposed to vary the speed of feeding of the tape towards the pair of punching cylinders. That is to say the tape is fed at the same constant speed of the magnetic cylinders when it passes between the blade sheets, then it is sharply decelerated and its direction of feed is reversed so as to move backwards when it passes between the zones of the magnetic cylinders without blade sheets. Finally it is once again accelerated to arrive at a constant speed at the blade sheets for the start of the new punching process. In this way the portion of non-punched tape in output from the punching assembly is reduced to a minimum or practically eliminated.

This system has disadvantages due both to the excessive strain whereto the tape is subjected due to the sudden accelerations and decelerations and to the constructional difficulties in synchronising the accelerations and the decelerations of the tape with the lay-out of the blade sheets and with the speed of rotation of the magnetic cylinders.

Printing machines comprise a plate support cylinder opposite a print contrast cylinder. On the plate support cylinder a printing plate is mounted, generally in the form of a shell. The length of the printing lay-out is produced by the length of the plate. Therefore the printing plate performs a function similar to that of the blade sheets of the punching machines; consequently the printing machines have the same disadvantages listed above for the punching machines.

Object of the present invention is to solve the disadvantages of the prior art, providing a punching or a printing machine and a relative punching or printing method which allow the strain on the tape material to be punched or printed to be reduced to a minimum.

Another object of the present invention is to provide a punching or a printing machine and a relative punching or printing method which are able to reduce to a minimum the waste of tape material during the punching or the printing.

Yet another object of the present invention is to provide a punching or a printing machine and a relative punching or printing method which are able to reduce to a minimum the down times of machine stoppage during production change.

Yet a further object of the present invention is to provide such a punching or printing machine, which is economical and simple to manufacture.

These objects are achieved in accordance with the invention with the punching machine, with the method of punching, with the printing machine and with the method of printing whose features are listed respectively in the appended independent claims.

Advantageous embodiments of the invention are disclosed in the dependent claims.

The punching machine for the punching of tape material, according to the invention, comprises a first punching turret provided with a pair of opposite rotating cylinders supporting respective punching blade sheets which define the shape and the lay-out of the punched parts to be obtained. The special feature of the invention is represented by the fact that the punching machine comprises at least a second punching turret placed in line with the first punching turret and provided with a pair of opposite rotating cylinders holding respective punching blade sheets, so that the tape is punched alternately by the first and by the second punching turret.

The printing machine for the printing of tape material according to the invention comprises a first printing turret provided with a print contrast cylinder and a plate support cylinder holding a printing plate, which defines the shape and lay-out of the print to be obtained. A second printing turret is placed in line with the first printing turret and is provided with a print contrast cylinder and a plate support cylinder holding a printing plate, in such a way that the tape is printed alternately by the first and by the second printing turret.

This system allows various types of blade sheets or of plates to be mounted on the cylinders in accordance with the shape of the punched parts or of the print to be obtained. Moreover the fact that the two punching or printing turrets operate alternately allows any waste of tape material to be avoided.

Moreover, with the system according to the invention, the feed rate of the tape is maintained constant and the speed of rotation of the cylinders is regulated according to the length of the punching blade sheets or of the printing plate, in this way eliminating the strain on the tape due to sudden accelerations and decelerations.

Further features of the invention will be made clearer by the following detailed description, referred to its embodiments given purely as a non-limiting example, illustrated in the accompanying drawings, wherein:

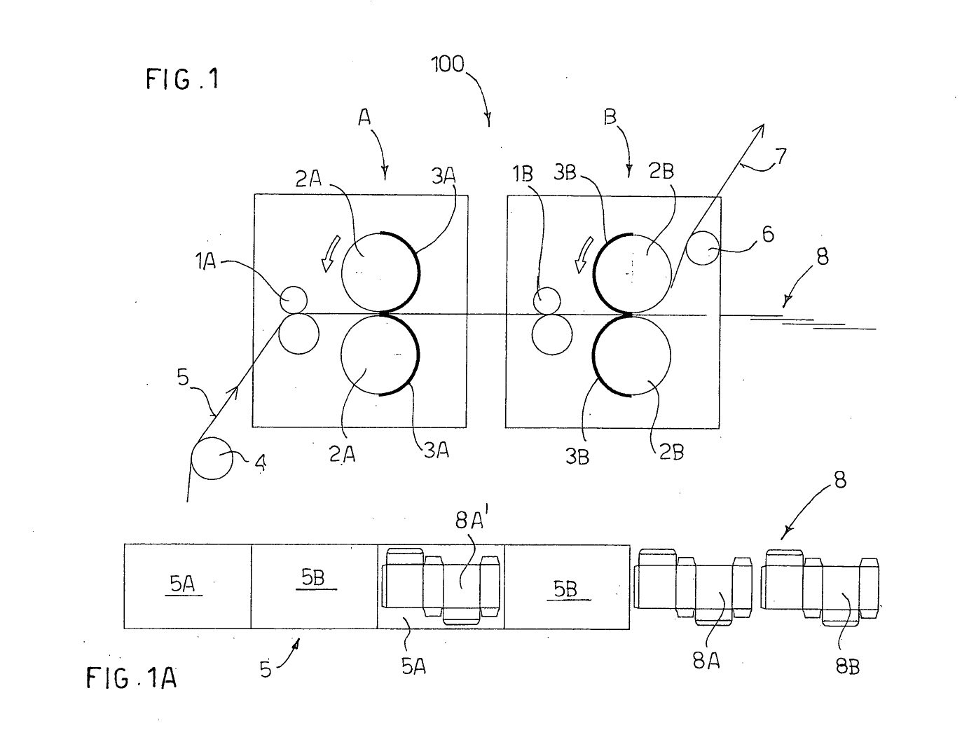

FIG. 1 is a schematic side elevation view illustrating a punching machine according to the invention, for the punching of cases;

FIG. 1A is a schematic plan view illustrating the tape fed into the punching machine of FIG. 1 and the punched parts obtained in output from this punching machine;

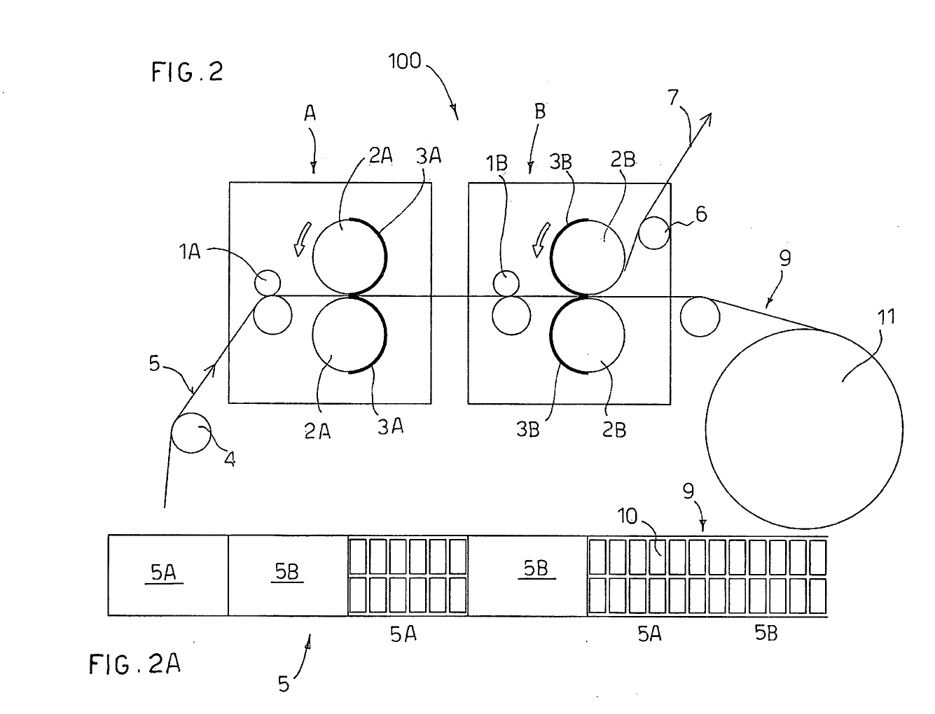

FIG. 2 is a view like FIG. 1, illustrating a punching machine according to the invention for the punching of self-adhesive labels;

FIG. 2A is a view like FIG. 1A, illustrating the tape fed into the punching machine of FIG. 2 and the punched labels obtained in output from this punching machine;

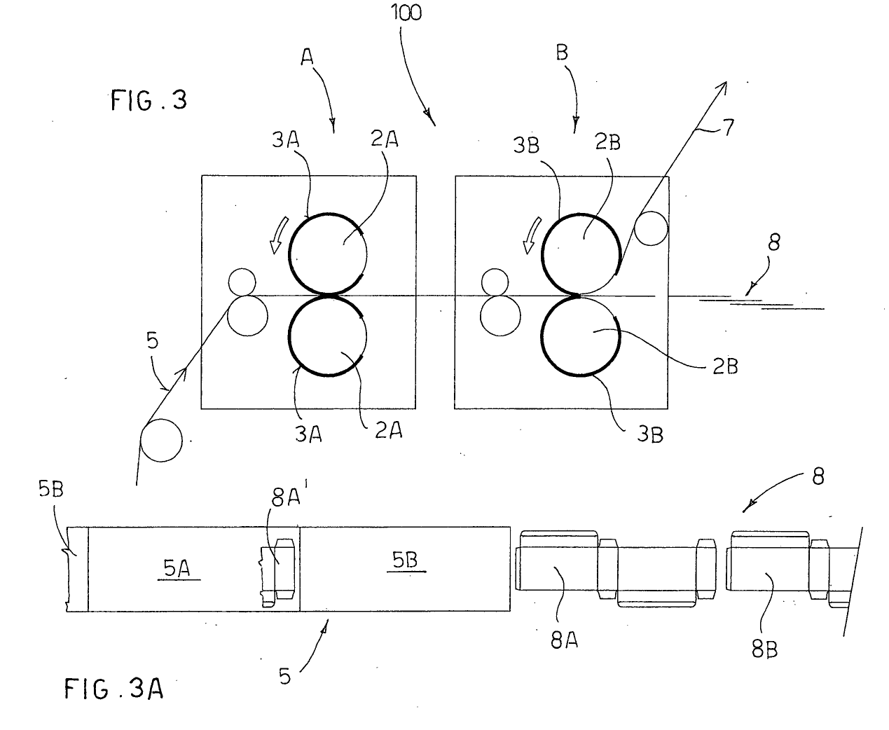

FIG. 3 is a view like FIG. 1, illustrating a punching machine according to the invention, wherein the blade sheet has a length greater than half of the length of the cylinder;

FIG. 3A is a plan view illustrating the tape fed into the punching machine of FIG. 3 and the punched parts obtained in output from this punching machine;

FIG. 3B is a diagram illustrating the curves of the speeds of the punching cylinders in the punching machine of FIG. 3;

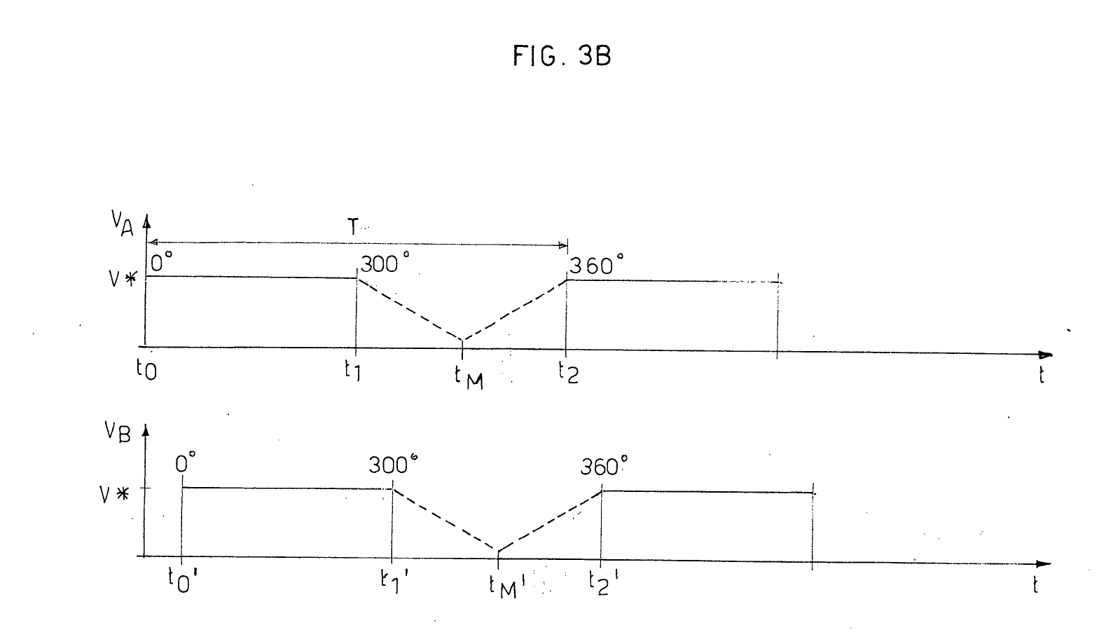

FIG. 4 is a view like FIG. 1, illustrating a punching machine according to the invention, wherein the blade sheet has a length smaller than half of the length of the cylinder;

FIG. 4A is a plan view illustrating the tape fed into the punching machine of FIG. 4 and the punched parts obtained in output from this punching machine;

FIG. 4B is a diagram illustrating the curves of the speeds of the punching cylinders in the punching machine of FIG. 4;

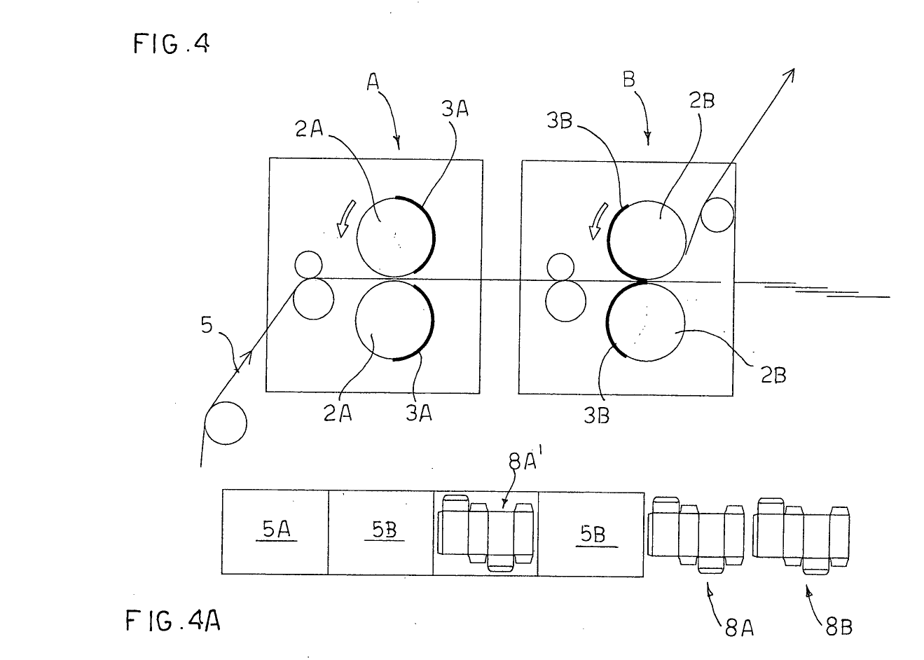

FIG. 5 is a view like FIG. 1, illustrating a punching machine according to the invention, wherein the blade sheet has a length equal to half the length of the cylinder;

FIG. 5A is a plan view illustrating the tape fed into the punching machine of FIG. 5 and the punched parts obtained in output from this punching machine;

FIG. 5B is a diagram illustrating the curves of the speeds of the punching cylinders in the punching machine of FIG. 5;

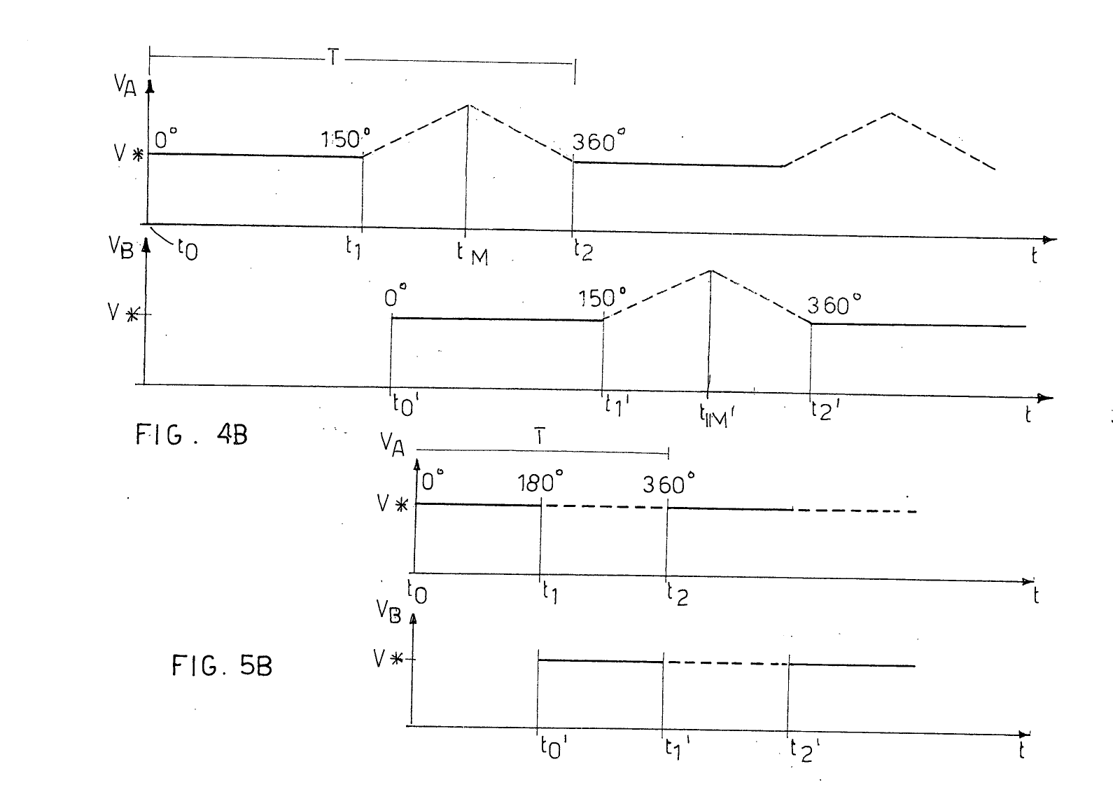

FIG. 6 is a partial cross section view taken along a vertical plane passing through the axis of the cylinders of a punching turret of the punching machine according to the invention, illustrating the system of movement of these cylinders;

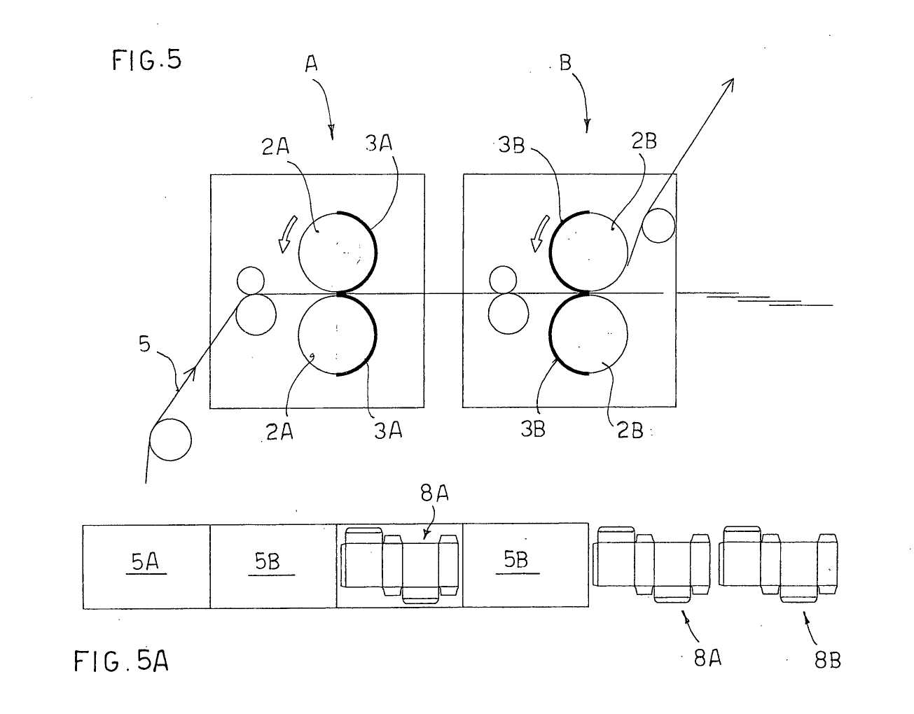

FIG. 7 is a view like FIG. 6, illustrating a second embodiment of the system for movement of the cylinders;

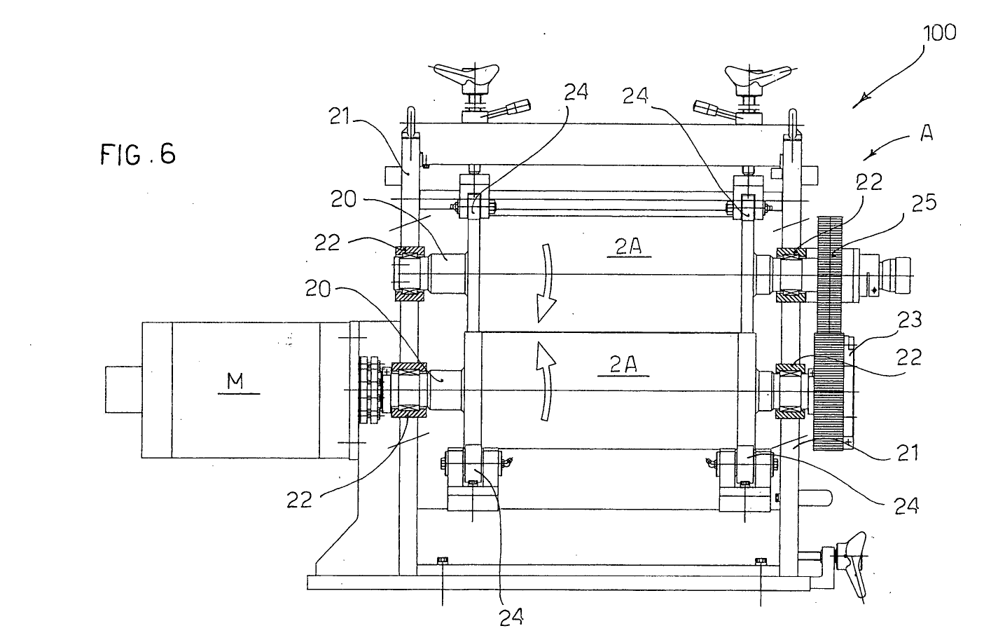

FIG. 8 is a schematic side elevation view illustrating a printing machine with two printing turrets for flexographic printing;

FIG. 8A is a schematic plan view illustrating the tape fed into the flexographic printing machine of FIG. 8 and the printed tape leaving this machine;

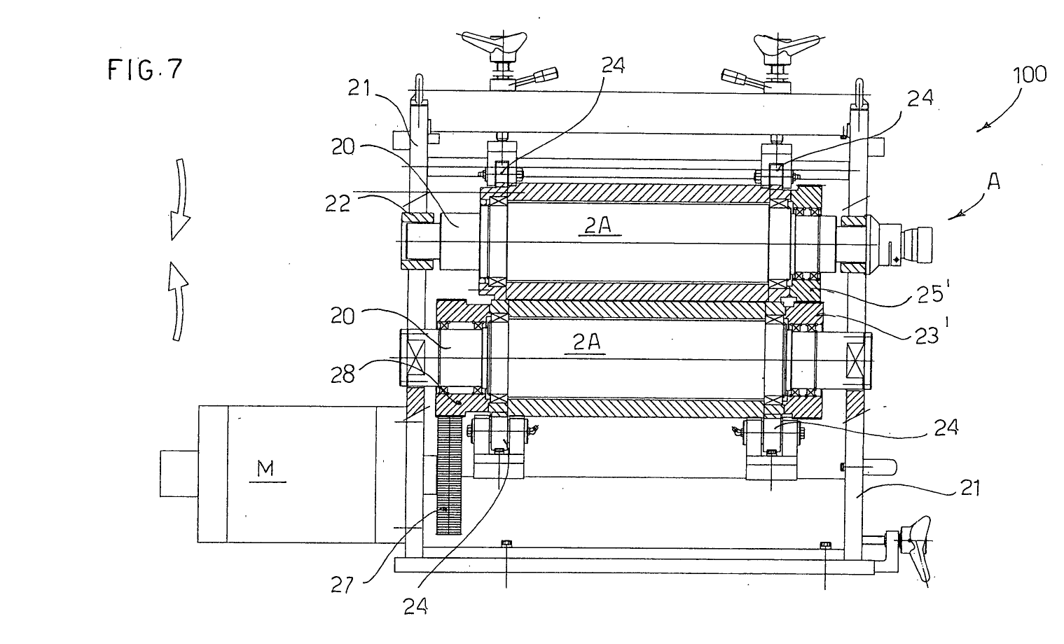

FIG. 9 is a schematic side elevation view illustrating a printing machine with two printing turrets for offset printing;

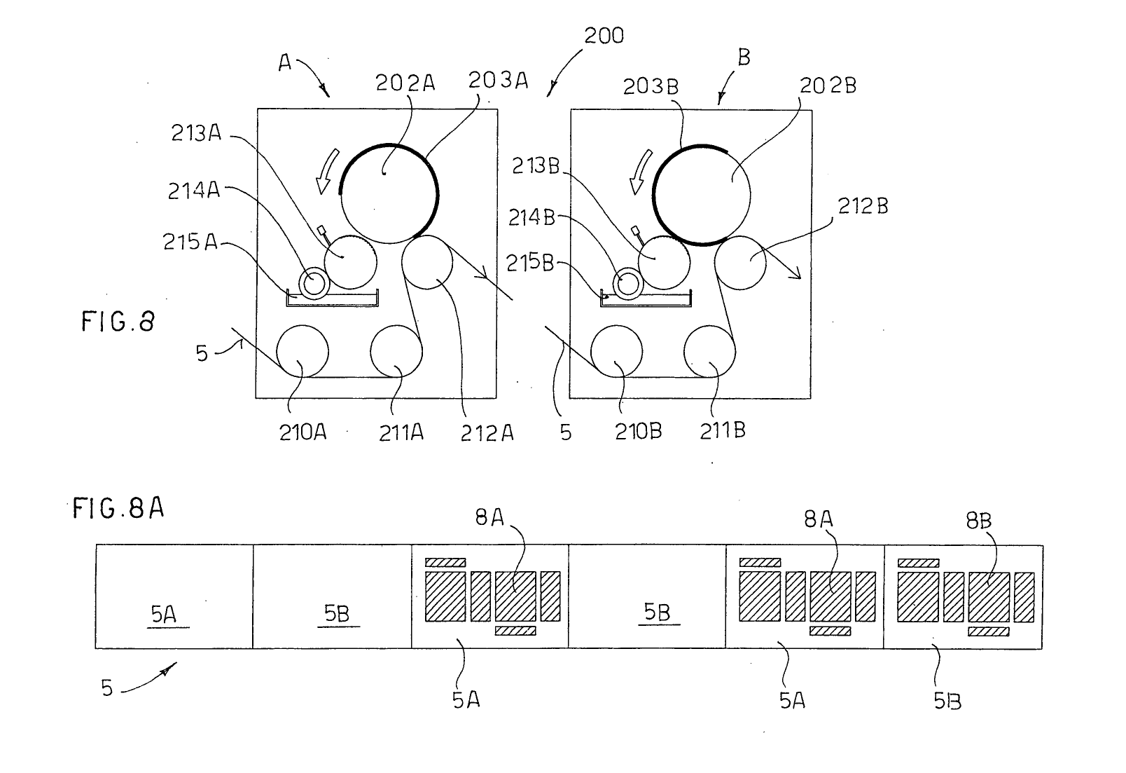

FIG. 10 is a schematic side elevation view illustrating a printing machine with two printing turrets for screen printing;

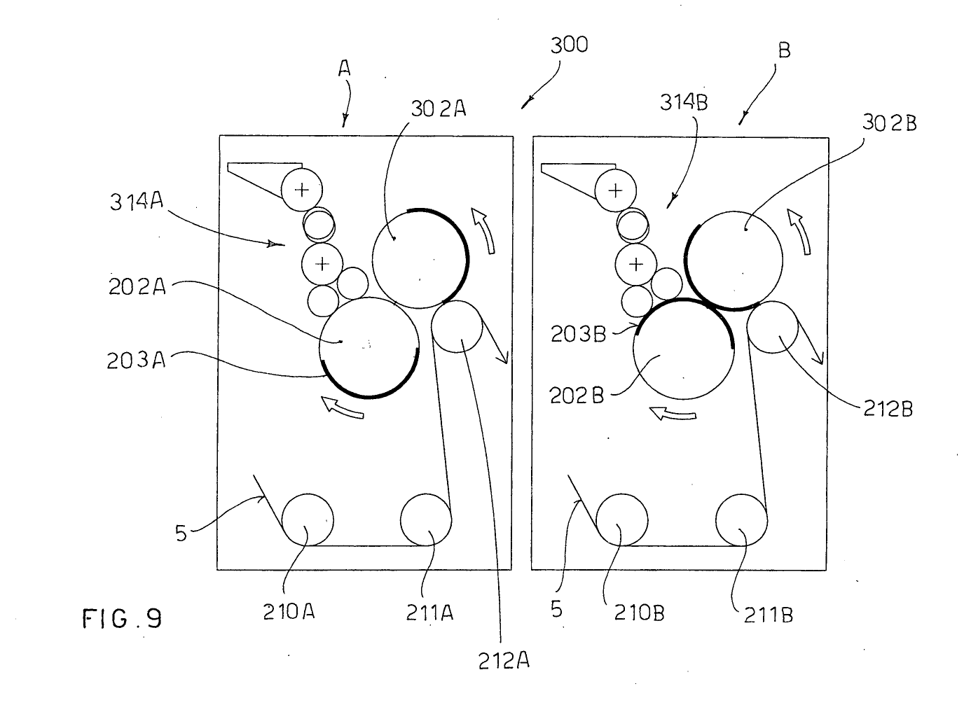

FIG. 11 is a schematic side elevation view illustrating a printing machine with two printing turrets for thermal printing;

With the aid of FIGS. 1-7 a description is given of the punching machine according to the invention, denoted overall by reference numeral 100.

As shown in FIGS. 1 and 2, the punching machine 100 comprises two punching turrets A and B placed in line in relation to the direction of feed of the tape to be punched 5.

Each punching turret (A, B) comprises respectively a drive unit (1A, 1B) provided with a presser roller and a pair of magnetic cylinders (2A, 2B). Alternatively, in a manner in itself known to a person skilled in the field, non-magnetic cylinders can be provided with blade sheets with another type of attachment, for example with mechanical means of attachment.

Each magnetic cylinder (2A, 2B) is designed to hold, by means of magnetic retaining a respective blade sheet (3A, 3B) having the configuration of a plate curved along an arc profile, with a radius of curvature substantially equal to the radius of curvature of the magnetic cylinder. The blade sheets (3A, 3B) have such a configuration as to cause the punching of a sheet material, according to a predefined shape.

Upstream of the drive unit 1A of the first punching turret A a idle roller 4 is provided which drives the tape material 5 to be punched towards the first punching turret A.

Downstream of the pair of magnetic cylinders 2B of the second punching turret a idle roller 6 is provided, designed to drive the web scrap 7 coming from punching of the tape material, which is collected separately, while the punched finished product comes out of the second punching turret B.

In the example in FIGS. 1 and 1A the finished product is represented by punched parts 8 separated one from the other and to be used for the production of cases. Instead in the example of FIGS. 2 and 2A the finished product is a strip 9 of punched self-adhesive labels 10 on a sheet material support. The strip of labels 9 is wound into a coil of large dimensions 11 downstream of the second punching turret B or alternatively it is conveyed in a different manner, for example zigzag folded up or as output sheets.

The tape 5 moves forwards in the punching machine 100 at a constant speed and is punched alternately by punching turrets A and B. For greater clarity, in FIGS. 1A and 2A the tape to be punched 5 has ideally been divided into alternate sectors 5A and 5B having a length equal to the length of the blade sheets 3A and 3B, respectively.

Referring to FIGS. 1 and 1A, when the tape 5 passes between the blade sheets 3A of the first punching turret A, the blade sheets 3A generate in a sector 5A of the tape a punched part 8A′ attached in points to the tape 5. In front of the punched part 8A′ attached in points there is a sector of non-punched tape 5B since it has passed between the magnetic cylinders 2A in the zone wherein the blade sheets 3A are not present.

With the forward feed of the tape, this non-punched sector 5B will pass between the blade sheets 3B of the second punching turret B where it will be punched in a traditional manner removing the web scrap 7, in such a way that a punched part 8B, separate from the tape 5, will come out of the second punching turret B.

With the forward feed of the tape, the punched part 8A′, attached in points, passes between the magnetic cylinders 2B of the second punching turret B, in the zone wherein the blade sheets 3B are not present. Therefore, by the pulling of the web scrap 7 and appropriate detaching devices, the punched part 8A′ attached in points is separated from the tape 5 so as to obtain a separate punched part 8A.

It should be noted that in this case the upstream turret A has to provide blade sheets 3A suitable for obtaining punching of a punched part attached in points to the tape, while the downstream turret B has to provide blade sheets 3B suitable for obtaining traditional punching with web scrap.

In the example of FIGS. 2 and 2A for the punching of self-adhesive labels, it is not necessary for the upstream punching turret A to provide punching with attachment in points. In fact, the self-adhesive labels 10 continue to be held on the support tape, even after their punching.

In FIGS. 3 and 3A an example is illustrated wherein the blade sheets 3A and 3B have a length greater than half the length of the magnetic cylinders 2A and 2B. For example the magnetic cylinders have an external circumference of 24 inches (60.96 cm) which develops along an angle from 0° to 360°. Instead the blade sheets have a length of 20 inches (50.8 cm) and develop on the circumference of the respective magnetic cylinder along an angle from 0° to 300°. Therefore the length of the punched parts 8A and 8B will be equal to 50.8 cm approximately.

In this case the axes distance between the cylinders 2A and 2B is set substantially equal to the total length of a cylinder (60.96 cm). The length of two sectors 5A and 5B of the tape 5 is equal to the sum of the lengths of two blade sheets (50.8+50.8=101.6 cm). Therefore the total length of the two sectors 5A and 5B is greater than the axes distance between the two cylinders 2A and 2B.

Consequently, as shown also in FIG. 3A, the second turret B starts to punch when the first turret A has punched only a first section of a punched part 8A′ attached in points to the tape 5, wherein the length of the first punched part 8A′ plus the length of the sector 5B is equal to the axes distance between the cylinders 2A and 2B (60.96 cm).

Instead, the length of the section of the sector 5A not yet punched by the turret A is 40.64 cm long and equal to the sum of the length of the two sectors 5A and 5B (101.6 cm) minus the axes distance between the cylinders 2A and 2B (60.96 cm). As a result, the first part 8A′ punched by the turret A has a length equal to 50.8−40.64=10.16 cm.

As shown in FIG. 3B, both for the cylinders 2A of the first turret and for the cylinders 2B of the second turret a constant punching speed V* is set. Considering to the initial instant in which the blade sheets 3A of the first turret A meet the tape 5, the speed of rotation of the cylinders 2A indicated by V_{A} will be maintained constant and equal to V* for the period of time t₁-t₀, that is to say for the period of time necessary for the blade sheet 3A to perform a rotation through an angle from 0° to 300°, equal to its length. Therefore the period of time t₁-t₀ corresponds to the punching time.

After the time t₁ the speed of rotation V_{A} of the magnetic cylinders 2A is decreased up to the time t_{M} and it is later increased up to the time t₂ wherein it is returned to the punching speed V*. In the time period t₂-t₁ the cylinders 2A must perform a rotation of 60°, that is to say the tape 5 must pass between the cylinders 2A in the section of circumference wherein the blade sheets 3A are not present. In this way, after the time t₂ the tape 5 will once again meet the blade sheets 3A at the constant speed of punching V*.

The curves of deceleration from t₁ to t_{M} and of acceleration from t_{M} to t₂, shown by a dotted line in the diagram, are set in such a way that the time period t₂-t₁ wherein punching does not occur is equal to the time period t₁-t₀ wherein punching occurs.

It should be noted that the speed curve V_{A} of the cylinders 2A is periodic, with period equal to T(t₂-t₀), wherein in the first half-period t₁-t₀ it is constant and in the second half time period t₂-t₁ first a deceleration and then an acceleration occurs.

As shown again in FIG. 3B, the speed curve V_{B} of the cylinders 2B of the second turret B has a trend substantially identical to that of the speed curve V_{A} of the first turret A.

In this case the blade sheets 3B of the second turret B start to punch at a time t₀′ shortly after the time t₀ wherein the blade sheets 3A of the first turret A have started to punch.

Therefore the curve V_{B} of the speeds of the cylinders 2B is shifted with respect to the curve V_{A} of the speeds of the cylinders 2A for a period of time equal to t₀′-t₀. The shift interval t₀′-t₀ is equal to the time taken by the cylinders 2A of the first turret A to punch the first punched part 8A′.

Clearly the shifting between the speeds VA and VB depends substantially on two factors, that is to say on the axes distance between the cylinders 2A and 2B and on the length of the blade sheets 3A and 3B.

The two groups of cylinders 2A and 2B are moved in rotation by independent motor drives controlled by actuators to perform the speed curves required. The motor drives are synchronised each other in such a way as to obtain the required shifting between the two speed curves V_{A} and V_{B}. For the synchronisation of the motor drives, devices within the reach of a person skilled in the field can be used, such as for example optical or magnetic encoders, which detect at all times the exact position of the blade sheets 3A and 3B.

FIGS. 4 and 4A illustrate an example wherein the blade sheets 3A and 3B have a smaller length in relation to half of the length of the magnetic cylinders 2A and 2B. For example the magnetic cylinders have an external circumference of 24 inches (60.96 cm) which develops along an angle from 0° to 360°. Instead the blade sheets have a length of 10 inches (25.4 cm) and develop on the circumference of the respective magnetic cylinder along an angle which ranges from 0° to 150°. Therefore the length of the punched parts 8A and 8B will be 25.4 cm approximately.

In this case the axes distance between the cylinders 2A and 2B is set substantially equal to the total length of a cylinder (60.96 cm). The length of two sectors 5A and 5B of the tape 5 is equal to the sum of the lengths of two blade sheets (25.4+25.4=50.8 cm). Therefore the total length of the two sectors (5A, 5B) is smaller than the axes distance between the two cylinders 2A and 2B.

Consequently, as shown also in FIG. 4A, the second turret B starts to punch a short time after the first turret A has finished to punch a complete punched part 8A′ attached in points to the tape 5.

In this case too the cylinders of the turret A rotate at a constant speed V* during the punching period t₁-t₀. Contrarily to what was seen previously, the cylinders 2A, after the time t₁ wherein they end punching, accelerate up to the time t_{M} and then decelerate up to the time t₂ wherein they return to the constant speed of punching V*.

In fact in this case, during the punching period t₁-t₀ the cylinders 2A must perform a rotation of only 150°, while during the non-punching period t₂-t₁ the cylinders 2A must perform a rotation of 210°, that is to say 360°-150°.

The curve V_{B} of the speeds of the cylinders 2B of the second turret B is substantially identical to the curve V_{A} of the speeds of the cylinders 2A of the first turret A. In this case it should be noted that the blade sheets 3B of the second turret B start punching at the time t₀′ just after the time t₁ wherein the blade sheets 3A of the first turret A have finished to punch. Consequently the shift interval t₀′-t₀ between the curves V_{A} and V_{B} is equal to the period of time t₁-t₀ of punching of the turret A plus the period of time t₀′-t₀ which is equal to the period of time necessary for the tape 5 to cover a section of 10.16 cm, that is to say the difference between the axes distance of cylinders 2A and 2B (60.96 cm) and the sum of sectors 5A and 5B (50.8 cm).

In FIGS. 5 and 5A a particular example is illustrated wherein the blade sheets 3A and 3B have a length equal to half the length of the magnetic cylinders 2A and 2B. For example the magnetic cylinders have an external circumference of 24 inches (60.96 cm) which develops along an angle from 0° to 360°. Instead the blade sheets have a length of 12 inches (30.48 cm) and develop on the circumference of the respective magnetic cylinder along an angle ranging from 0° to 180°. Therefore the length of the punched parts 8A and 8B will be 30.48 cm approximately.

In this case the axes distance between the cylinders 2A and 2B is set substantially equal to the total length of the circumference of a cylinder (60.96 cm). The length of two sectors 5A and 5B of the tape 5 is equal to the sum of the lengths of two blade sheets (30.48+30.48=60.96 cm). Therefore the total length of the two sectors 5A and 5B is equal to the axes distance between the two cylinders 2A and 2B.

As shown also in FIG. 5A, when the first turret A has finished punching the complete punched part 8A′ attached in points to the tape 5, the second turret B starts immediately to punch the relative sector of tape 5B.

In this case the cylinders of turret A always rotate at a constant speed V* both during the punching period t₁-t₀ and during the non-punching period t₂-t₀.

In fact in this case the cylinders 2A must always perform a rotation of 180° both during the punching period t₁-t₀ and during the non-punching period t₂-t₁. Therefore, so that the punching period t₁-t₀ is equal to the non-punching period t₂-t₁, no acceleration and deceleration of the rotation speed of the cylinders 2A are necessary. Therefore the rotation speed V_{A} of the cylinders 2A can be maintained always constant at V*.

Also the curve V_{B} of the speed of cylinders 2B of the second turret B is always constant at V*. In this case it should be noted that the blade sheets 3B of the second turret B start punching at the time t₀′ coinciding with the time t₁ wherein the blade sheets 3A of the first turret A have ended punching.

Therefore the shift interval t₀′-t₀ between the two speed curves V_{A} and V_{B} is equal to half the period of the waveform T/2 that is to say to the period of time t₁-t₀ necessary for the blade sheets 3A to perform a complete punching.

As limit case, in the case wherein the length of the punched parts has to be equal to the full length of the cylinders 2A or 2B, only the punching turret B can be used with blade sheets 3B covering the entire circumference of the cylinders 2B.

FIG. 6 illustrates an example of moving of the cylinders 2A of the first punching turret A, without detriment to the fact that movement of the cylinders 2B of the second punching turret B is totally identical. The magnetic cylinders 2A are mounted fixed on respective spindles 20. The spindles 20 are mounted rotatingly in bearings 22 supported in the sides 21 of the frame of turret A.

The axes of the spindles 20 are horizontal and parallel each other, so that the side surfaces of the cylinders 2A can be tangent each other.

A motor M operates by directly gripping the end of a spindle 20 in order to rotate it.

The driving spindle 20 has at the opposite end to the motor M a gear 23 which meshes with a second gear 25 keyed to the end of the other spindle 20. In this way the two spindles 20 rotate in opposite directions and at the same speed.

At the ends of the cylinders 2A adjustment devices 24 adjust the cylinders 2A transversely and longitudinally.

FIG. 7 illustrates a second example of movement of the cylinders 2A, wherein elements corresponding to those already described are denoted by the same reference numerals. In this case the spindles 20 are mounted fixed in the sides of the machine 21 and the magnetic cylinders 2A are mounted rotatingly on respective spindles 20.

The motor M has a drive shaft with a pinion 27, which meshes a gear 28 integral with a cylinder 2A. The drive cylinder 2A has at the end opposite to the motor M a gear 23′ which meshes with a second gear 25′ integral with the other cylinder 2A.

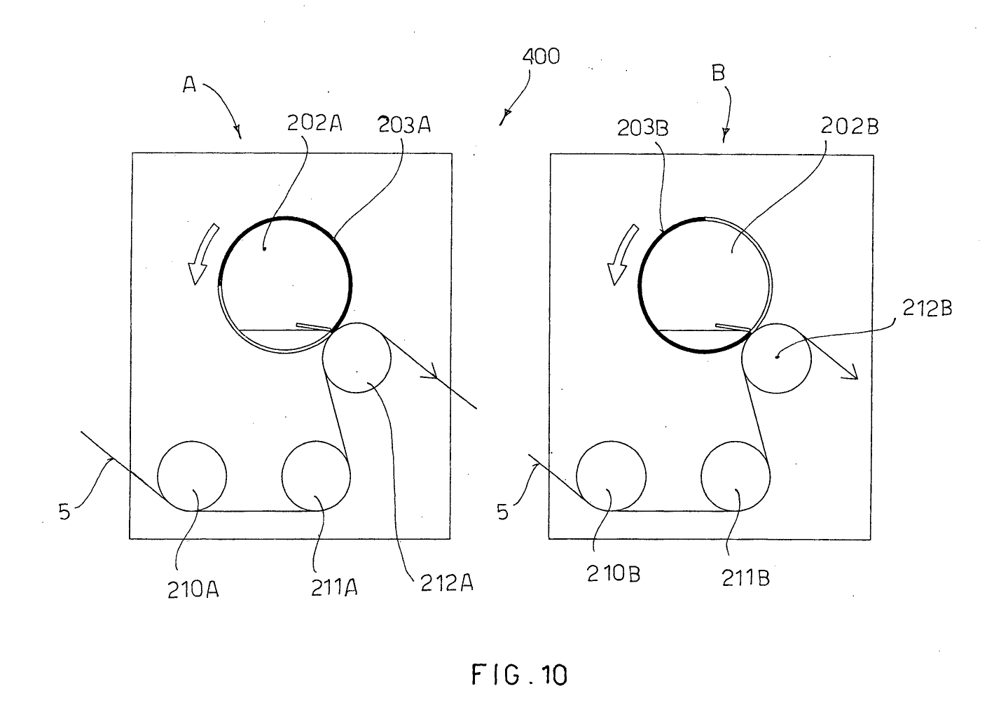

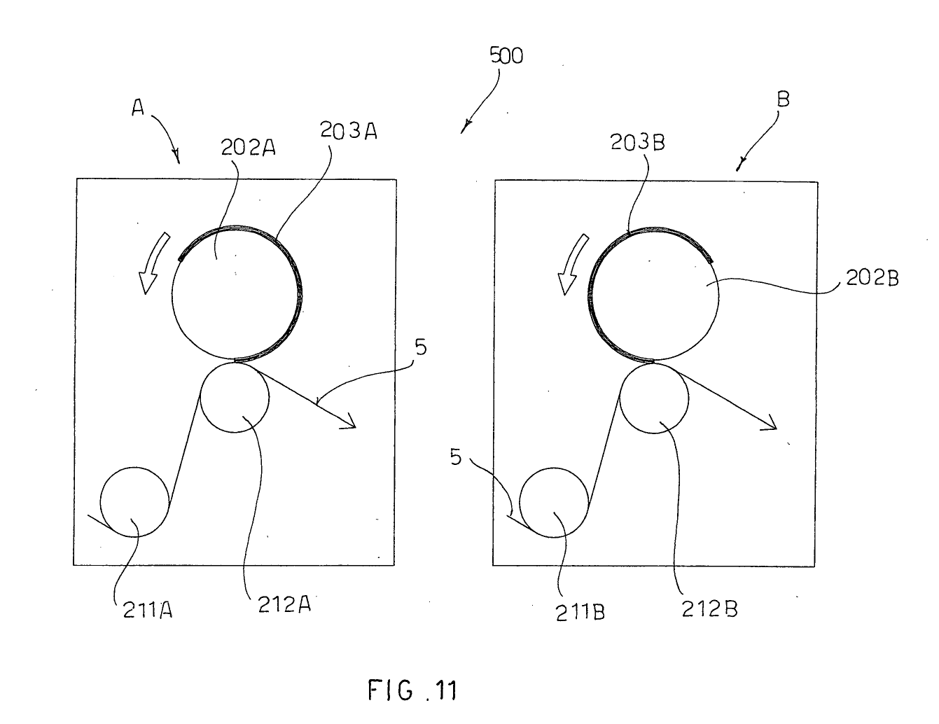

Referring to FIGS. 8-13, a description is given of the system according to the invention applied to a printing machine.

FIG. 8 illustrates a flexographic printing machine 200 comprising two printing turrets A and B placed in line in relation to the direction of feed of the tape 5 to be printed.

Each printing turret comprises two idle rollers (210A, 211A, 210B, 211B) which drive the tape 5 towards a pair of opposite cylinders comprising a print contrast cylinder (212A, 212B) and a plate support cylinder (202A, 202B). On the plate support cylinder (202A, 202B) a plate (203A, 203B) is mounted which defines the lay-out to be printed.

An anilox cylinder (213A, 213B) is placed tangent to the plate support cylinder (202A, 202B) and holds the ink which is spread thereon by an inking roller (214A, 214B) which draws the ink from a basin (215A, 215B) forming part of a doctor unit.

The tape 5 moves forwards in the printing machine 200 at constant speed and is printed alternately by the printing turrets A and B. For greater clarity, in FIG. 8A the tape 5 to be printed has ideally been divided into alternate sectors 5A and 5B having a length respectively equal to the length of the plates 203A and 203B.

Referring to FIGS. 8 and 8A, when the tape 5 passes between the plate 203A and the print contrast cylinder 212A of the first printing turret A, the plate 203A generates a print 8A in a sector 5A of the tape. In front of the print 8A there is a sector of non-printed tape 5B, as it has passed between the plate support cylinder 202A and print contrast cylinder 212A in the zone wherein the plate 203A is not present.

With the forward movement of the tape 5, this non-printed sector 5B will pass between the plate 203B and the print contrast cylinder 212B of the second printing turret B where it will be printed, in such a way that a tape with adjacent printed sectors (8A, 8B) will come out of the second printing turret B.

Herein below parts which are the same as or correspond to those already described are denoted by the same reference numerals and their detailed description is omitted.

FIG. 9 illustrates an offset printing machine 300 comprising two printing turrets A and B placed in line in relation to the direction of feed of the tape 5 to be printed. Each printing turret comprises a plate support cylinder (202A, 202B) whereon a plate (203A, 203B) is attached, represented by an offset printing plate in itself known. In this case, between the print contrast cylinder (212A, 212B) and the plate support cylinder (202A, 202B), a rubber or caoutchouc cylinder (302A, 302B) is placed, whereon the impression to be printed, engraved on the plate (203A, 203B), is transferred. The caoutchouc cylinder (302A, 302B) in turn transfers the impression onto the tape 5 which is fed between it and the print contrast cylinder (212A, 212B).

Each offset printing turret comprises a group of inking rollers (314A, 314B) for depositing the ink on the plate (203A, 203B); moreover it can also comprise a group of wetting rollers for moistening the portion of plate support cylinder (202A, 202B) wherein the plate (203A, 203B) is not present.

In this case too, in accordance with the lay-out of the plate (203A, 203B), the printing sequence is the same as that illustrated in FIG. 8A with reference to a flexographic printing.

FIG. 10 illustrates a screen printing machine 400 comprising two printing turrets A and B placed in line in relation to the direction of feed of the tape 5 to be printed. Each printing turret comprises a plate support cylinder (202A, 202B) whereon a plate (203A, 203B) in the form of a roll engraved for screen printing (in itself known) is attached, wherein the engravings represent the lay-out of printing. The ink is contained in the plate support cylinder (202A, 202B) and it passes through the engravings of the plate (203A, 203B) for printing on the tape 2 fed between the plate (203A, 203B) and the print contrast cylinder (212A, 212B).

In this case too, in accordance with the lay-out of the plate 203A, 203B, the printing sequence is the same as that illustrated in FIG. 8A with reference to a flexographic printing.

FIG. 11 illustrates a thermal printing machine 500 comprising two printing turrets A and B placed in line in relation to the direction of feed of the tape 5 to be printed. Each printing turret comprises a plate support cylinder (202A, 202B) whereon a plate (203A, 203B) is attached, soaked in ink which is activated by the heat. The plate support cylinder (202A, 202B) is heated so that the ink on the plate (203A, 203B) is activated and transferred to the tape 5 fed between the plate (203A, 203B) and the print contrast cylinder (212A, 212B).

In this case too, in accordance with the lay-out of the plate (203A, 203B), the printing sequence is the same as that illustrated in FIG. 8A with reference to a flexographic printing.

In case of plates (203A, 203B) of average size with length equal to half the length of the plate support cylinder (202A, 202B), the diagrams of the speeds of the plate support cylinders (202A, 202B) correspond to those of FIG. 5B. That is to say the plate support cylinders (202A, 202B) are always rotated at constant speed V*.

Obviously plates, which are small in size, can be provided, for example, with a smaller length in relation to half the circumference of the plate support cylinder (FIG. 9). In this case the diagrams of the speeds of the plate support cylinders correspond to those of FIG. 4B. That is to say the plate support cylinders (202A, 202B) are always rotated at constant speed V* in the period wherein the plate is in contact with the tape. Instead, in the period wherein the plate is not in contact with the tape the plate support cylinders are accelerated and then decelerated to bring them again to the constant speed V* at which the plate meets the tape, in such a way that the period wherein the plate is in contact with the tape is equal to the period wherein the plate is not in contact with the tape.

Large size plates can also be provided, for example with a length larger than half the circumference of the plate support cylinder (FIGS. 8, 10 11). In this case the diagrams of the speeds of the plate support cylinders correspond to those of FIG. 3B. That is to say the plate support cylinders (202A, 202B) are always rotated at constant speed V* in the period wherein the plate is in contact with the tape. Instead in the period wherein the plate is not in contact with the tape, the plate support cylinders are decelerated and then accelerated to bring them again to the constant speed V* at which the plate meets the tape, in such a way that the period wherein the plate is in contact with the tape is equal to the period wherein the plate is not in contact with the tape.

Obviously the printing turrets A and B are spaced one from the other, also because drying units and the like are positioned between them. In any case the path of the tape 5 from the output of turret A to the input of turret B is studied in such a way as to ensure that the plate 203B of the second plate support cylinder 202B meets the tape 5 in the appropriate sector 5B, in this way avoiding overlaps with the sector 5A of tape which has been printed with the print 8A by the plate 203A of the first plate support cylinder 202A.

The first and second plate support cylinders (202A, 202B) are driven to rotate by respective independent motor drives synchronised each other by means of encoders or other devices which detect the position of the plates (203A, 203B).

Numerous variations and detail changes can be made to the present embodiments of the invention within the reach of an expert in the field, and in any case within the sphere of the invention disclosed in the annexed claims.

1. A punching machine (100) for the punching of tape material (5) comprising a first punching turret (A) provided with a pair of opposite rotating cylinders (2A) holding respective punching blade sheets (3A) which define the shape and the lay-out of the punched parts (8, 9) to be obtained, wherein it comprises at least one second punching turret (B) placed in line with the first punching turret (A) and provided with a pair of opposite rotating cylinders (2B) holding respective punching blade sheets (3B), in such a way that the tape is punched alternately by the first and by the second punching turret (A, B).

2. A punching machine (100) according to claim 1, wherein the rate of feed of the tape (5) towards the first and the second punching turret (A, B) is constant.

3. A punching machine (100) according to claim 1, wherein the speeds of rotation (V_{A}, V_{B}) of the cylinders (2A, 2B) of the first and of the second punching turret (A, B) are set at a constant punching speed (V*) during the period of time wherein the tape (5) passes between the respective blade sheets (3A, 3B) and in that each rotation speed (V_{A}, V_{B}) of the cylinders (2A, 2B) of the first and of the second punching turret (A, B) is set in such a way that the period of time (t₁-t₀) during which the tape (5) passing between the blade sheets (3A, 3B) of the cylinders (2A, 2B) is punched is equal to the period of time (t₂-t₁) during which the tape (5), passing between the zones of the cylinders (2A, 2B) without blade sheets, is not punched.

4. A punching machine (100) according to claim 3, wherein the length of the blade sheets (3A, 3B) is greater than half of the length of the respective cylinders (2A, 2B) and in that, during the period of time (t₂-t₁) wherein the tape (5) is not punched, the cylinders (2A, 2B) first decelerate and then accelerate.

5. A punching machine (100) according to claim 3, wherein the length of the blade sheets (3A, 3B) is smaller than half of the length of the respective cylinders (2A, 2B) and in that, during the period of time (t₂-t₁) wherein the tape (5) is not punched, the cylinders (2A, 2B) first decelerate and then accelerate.

6. A punching machine (100) according to claim 3, wherein the length of the blade sheets (3A, 3B) is equal to half of the length of the respective cylinders (2A, 2B) and in that both during the period of time (t₂-t₁) wherein the tape (5) is not punched and during the period of time (t₁-t₀) wherein the tape (5) is punched, the cylinders (2A, 2B) rotate at constant speed (V*).

7. A punching machine (100) according to claim 1, wherein it is used for punching cases (8′) wherein the blade sheets (3A) of the cylinders (2A) of the first punching turret (A) perform punching on a punched part (8A′) attached in points to the tape material (5) and the blade sheets (3B) of the cylinders (2B) of the second punching turret (B) perform a complete traditional punching with web scrap (7) and/or in that it is used for punching self-adhesive labels (10) punched on a support tape (5) which is wound into a coil (11) or otherwise conveyed.

8. A punching machine (100) according to claim 1, wherein the first and the second pairs of cylinders (2A, 2B) are driven to rotate by respective independent motor drives (M) synchronised each other by means of encoders or of other devices which detect the position of said blade sheets (3A, 3B).

9. A method for the punching of tape material (5) comprising the step of feeding the tape material (5) towards a first punching turret (A) provided with a pair of opposite rotating cylinders (2A) supporting respective punching blade sheets (3A) which define the shape and the lay-out of the punched parts (8, 9) to be obtained, wherein it comprises the step of feeding the tape (5) towards at least one second punching turret (B) placed in line with the first punching turret (A) and provided with a pair of opposite rotating cylinders (2B) holding respective punching blade sheets (3B), in such a way that the tape is punched alternately by the first and by the second punching turret (A, B).

10. A method of punching according to claim 9, wherein the rate of feed of the tape (5) towards the first and the second punching turret (A, B) is constant.

11. A method of punching according to claim 10, wherein the speeds of rotation (V_{A}, V_{B}) of the cylinders (2A, 2B) of the first and of the second punching turret (A, B) are set at a constant speed of punching (V*) during the period of time wherein the tape passes between the respective blade sheets (3A, 3B) and in that each speed of rotation (V_{A}, V_{B}) of the cylinders (2A, 2B) of the first and of the second punching turret (A, B) is set in such a way that the period of time (t₁-t₀) during which the tape (5), passing between the blade sheets (3A, 3B) of the cylinders (2A, 2B), is punched is equal to the period of time (t₂-t₁) during which the tape (5), passing between the zones of the cylinders (2A, 2B) without blade sheets, is not punched.

12. A method of punching according to claim 11, wherein the length of the blade sheets (3A, 3B) is greater than half of the length of the respective cylinders (2A, 2B) and in that, during the period of time (t₂-t₁) wherein the tape (5) is not punched, the cylinders (2A, 2B) first decelerate and then accelerate.

13. A method of punching according to claim 11, wherein the length of the blade sheets (3A, 3B) is smaller than half of the length of the respective cylinders (2A, 2B) and in that, during the period of time (t₂-t₁) wherein the tape (5) is not punched, the cylinders (2A, 2B) first accelerate and then decelerate.

14. A method of punching according to claim 11, wherein the length of the blade sheets (3A, 3B) is equal to half of the length of the respective cylinders (2A, 2B) and in that, both during the period of time (t₂-t₁) wherein the tape (5) is not punched and during the period of time (t₁-t₀) wherein the tape (5) is punched, the cylinders (2A, 2B) rotate at constant speed (V*).

15. A method of punching according to claim 9, wherein it provides for punching of cases (8′) wherein the blade sheets (3A) of the cylinders (2A) of the first punching turret (A) perform a punching of a punched part (8A′) attached in points to the tape material (5) and the blade sheets (3B) of the cylinders (2B) of the second punching turret (B) perform a complete traditional punching with web scrap (7) and/or in that it provides for the punching of self-adhesive labels (10) punched on a support strip (5) which is wound into a coil (11) or another system of collection.

16. A method of punching according to claim 9, wherein the first and second pair of cylinders (2A, 2B) are driven to rotate by respective independent motor drives (M) synchronised each other by means of encoders or of other devices which detect the position of said blade sheets (3A, 3B).

17. A printing machine (200, 300, 400, 500) for printing tape material (5) comprising a first printing turret (A) provided with a print contrast cylinder (212A) and a plate support cylinder (202A) holding a printing plate (203A) which defines the shape and the lay-out of the print to be obtained, wherein it comprises at least one second printing turret (B) placed in line with the first printing turret (A) and provided with a print contrast cylinder (212B) and a plate support cylinder (202B) holding a printing plate (203B) in such a way that the tape is printed alternately by the first and by the second printing turret (A, B).

18. A printing machine according to claim 17, wherein the rate of feeding of the tape (5) towards the first and the second printing turret (A, B) is constant.

19. A printing machine according to claim 17, wherein the rotation speeds (V_{A}, V_{B}) of the plate support cylinders (202A, 202B) of the first and of the second printing turret (A, B) are set at a constant speed of printing (V*) during the period of time wherein the tape passes in contact with the respective plates (203A, 203B) and in that each speed of rotation (V_{A}, V_{B}) of the plate support cylinders (202A, 202B) of the first and the second printing turret (A, B) is set in such a way that the period of time during which the tape (5), passing in contact with the plates (3A, 3B) of the plate support cylinders (202A, 202B), is printed is equal to the period of time during which the tape (5), passing over the zones of the plate support cylinders (202A, 202B) without plates, is not printed.

20. A printing machine according to claim 19, wherein the length of the plates (203A, 203B) is greater than half to the length of the respective plate support cylinders (202A, 202B) and in that, during the period of time wherein the tape (5) is not printed, the plate support cylinders (202A, 202B) first decelerate and then accelerate.

21. A printing machine according to claim 19, wherein the length of the plates (203A, 203B) is smaller than half to the length of the respective plate support cylinders (202A, 202B) and in that, during the period of time wherein the tape (5) is not printed, the plate support cylinders (202A, 202B) first accelerate and then decelerate.

22. A printing machine according to claim 19, wherein the length of the plates (203A, 203B) is equal to half to the length of the respective plate support cylinders (202A, 202B) and in that, both during the period of time wherein the tape (5) is not printed and during the period of time wherein the tape (5) is printed, the plate support cylinders (202A, 202B) rotate at constant speed (V*).

23. A printing machine according to claims 17, wherein it is used for flexographic printing, offset printing, screen printing and/or thermal printing.

24. A printing machine according to claim 17, characterised in that the first and second plate support cylinders (202A, 202B) are driven to rotate by respective independent motor drives synchronised each other by means of encoders or of other devices which detect the position of said plates (203A, 203B).

25. A method for printing tape material (5) comprising the step of feeding the tape material (5) towards a first printing turret (A) provided with a print contrast cylinder (212A) and a plate support cylinder (202A) holding a printing plate (203A) which defines the shape and the lay-out of the print to be obtained, wherein it comprises the step of feeding the tape (5) towards at least one second printing turret (B) placed in line with the first printing turret (A) and provided with a print contrast cylinder (212B) and a plate support cylinder (202B) holding a printing plate (203B), in such a way that the tape is printed alternately by the first and by the second printing turret (A, B).

26. A printing method according to claim 25, wherein the rate of feed of the tape (5) towards the first and second printing turret (A, B) is constant.

27. A printing method according to claim 26, wherein the rotation speeds (VA, VB) of the plate support cylinders (202A, 202B) of the first and of the second printing turret (A, B) are set at a constant speed of sprinting (V*) during the period of time wherein the tape passes in contact with the respective plates (203A, 203B) and in that each rotation speed (V_{A}, V_{B}) of the plate support cylinders (202A, 202B) of the first and of the second printing turret (A, B) is set in such a way that the period of time during which the tape (5), passing over the plates (203A, 203B) of the plate support cylinders (202A, 202B), is printed is equal to the period of time during which the tape (5), passing over the zones of the plate support cylinders (202A, 202B) without plate, is not printed.

28. A printing method according to claim 27, wherein the length of the plates (203A, 203B) is greater than half to the length of the respective plate support cylinders (202A, 202B) and in that, during the period of time wherein the tape (5) is not printed, the plate support cylinders (202A, 202B) first decelerate and then accelerate.

29. A printing method according to claim 27, wherein the length of the plates (203A, 203B) is smaller than half to the length of the respective plate support cylinders (202A, 202B) and in that, during the period of time wherein the tape (5) is not printed, the plate support cylinders (202A, 202B) first accelerate and then decelerate.

30. A printing method according to claim 27, wherein the length of the plates (203A, 203B) is equal to half to the length of the respective plate support cylinders (202A, 202B) and in that both during the period of time wherein the tape (5) is not printed and during the period of time wherein the tape (5) is printed the plate support cylinders (202A, 202B) rotate at constant speed (V*).

31. A printing method according to claim 25, wherein it provides for flexographic printing, offset printing, screen printing and/or thermal printing.

32. A printing method according to claim 25, wherein the first and the second plate support cylinders (202A, 202B) are driven to rotate by respective independent motor drives synchronised each other by means of encoders or other devices which detect the position of said plates (203A, 203B).
